(19) United States
(12) Patent Application Publication
(10) Pub. No.: US 2011/0261265 A1
(43) Pub. Date: Oct. 27, 2011

(54) METHOD FOR PROVIDING A VIDEO PLAYBACK DEVICE WITH A SOURCE SELECTION FUNCTION USING IMAGE REPRESENTATIVES OF INPUT TERMINALS, AND ASSOCIATED VIDEO PLAYBACK DEVICE AND ASSOCIATED PROCESSING CIRCUIT

(76) Inventor: Zhe Zhao, Anhui Province (CN)

(21) Appl. No.: 12/746,765

(22) PCT Filed: Apr. 23, 2010
(86) PCT No.: PCT/CN10/72159

§ 371 Date: Jun. 8, 2010

(51) Int. Cl. H04N 5/268; H04N 5/44

(52) U.S. Cl. 348/706; 348/734; 348/E05.057; 348/E05.096

(57) ABSTRACT

A method for providing a video playback device with a source selection function includes: providing the video playback device with a user interface of the source selection function for displaying image representatives of a plurality of input terminals of the video playback device at the same time; and selecting a signal corresponding to a specific input terminal of the input terminals in response to user selection, in order to make images carried by the selected signal be displayed. An associated video playback device and an associated processing circuit are provided. In particular, the processing circuit includes: a controller arranged to control operations of the video playback device; and a program code embedded in the controller or received from outside the controller, where the controller executing the program code is arranged to provide the user interface of the source selection function for displaying the image representatives at the same time.

### TECHNICAL FIELD

The present invention relates to source signal selection of a video playback device, and more particularly, to a method for providing a video playback device with a source selection function, and to an associated video playback device and an associated processing circuit.

### BACKGROUND

Please refer to FIGS. 1A-1C, which illustrate input terminal names 12-1, 12-2, and 12-3 that are displayed in turns on a screen 10 of a conventional liquid crystal display television (LCD TV) during terminal switching according to the related art. For example, during the terminal switching of the LCD TV, a user first switches from an input terminal named “CABLE” to an input terminal named “S-Video”, and then switches to an input terminal named “AV1”. The conventional LCD TV does not serve the user well since there is not sufficient information for the user to accurately switch to a target input terminal connected to a specific source device that the user really wants, causing many problems of using the LCD TV.

More specifically, the user is typically forced to switch among a lot of input terminals, and has no idea of whether a next input terminal is connected to the specific source device that the user really wants. Typically, on a remote controller of the LCD TV, there is only one button for terminal switching since the size and associated costs of the remote controller are intended to be limited. In a situation where a first user uses a first source device such as a Blu-ray Disc (BD) player connected to a first input terminal of the LCD TV and then turns off the LCD TV and the first source device, when a second user turns on the LCD TV to use a second source device such as a set top box (STB), the first input terminal receives no signal and therefore the LCD TV typically displays nothing, causing inconvenience for the second user. In addition, in a situation where the second user is not familiar with the connection relationships between the input terminals and the source devices, the second user is typically forced to waste time on figuring out what to do next or blindly trying with some other input terminals.

As mentioned, the conventional LCD TV does not serve the user well. Thus, a novel method is required for enhancing the viewing experience of the users.

### SUMMARY

It is therefore an objective of the claimed invention to provide a method for providing a video playback device with a source selection function, and to provide an associated video playback device and an associated processing circuit, in order to solve the above-mentioned problems.

An exemplary embodiment of a method for providing a video playback device with a source selection function comprises: providing the video playback device with a user interface of the source selection function for displaying image representatives of a plurality of input terminals of the video playback device at a same time; and selecting a signal corresponding to a specific input terminal of the input terminals in response to user selection, in order to make images carried by the selected signal be displayed.

An exemplary embodiment of an associated video playback device provided with a source selection function comprises a processing circuit and a selector. The processing circuit is arranged to provide the video playback device with a user interface of the source selection function for displaying image representatives of a plurality of input terminals of the video playback device at a same time. In addition, the selector is arranged to select a signal corresponding to a specific input terminal of the input terminals in response to user selection, in order to make images carried by the selected signal be displayed.

An exemplary embodiment of an associated processing circuit for controlling a video playback device and providing the video playback device with a source selection function comprises: a controller arranged to control operations of the video playback device; and a program code embedded in the controller or received from outside the controller. In addition, the controller executing the program code is arranged to provide a user interface of the source selection function for displaying image representatives of a plurality of input terminals of the video playback device at a same time. Additionally, under control of the processing circuit, a selector of the video playback device is arranged to select a signal corresponding to a specific input terminal of the input terminals in response to user selection, in order to make images carried by the selected signal be displayed.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIGS. 1A-1C illustrate input terminal names that are displayed in turns on a screen during terminal switching according to the related art.

FIG. 2 is a diagram of a video playback device provided with a source selection function according to a first embodiment of the present invention.

FIGS. 3A-3B illustrate some examples of the video playback device shown in FIG. 2 according to different embodiments of the present invention.

FIG. 4 is a flowchart of a method for providing a video playback device with a source selection function according to an embodiment of the present invention.

FIG. 5 illustrates an exemplary user interface arrangement according to a special case of the embodiment shown in FIG. 4.

FIG. 6 illustrates an exemplary user interface arrangement according to another special case of the embodiment shown in FIG. 4.

FIG. 7 illustrates implementation details of the method shown in FIG. 4 according to an embodiment of the present invention.

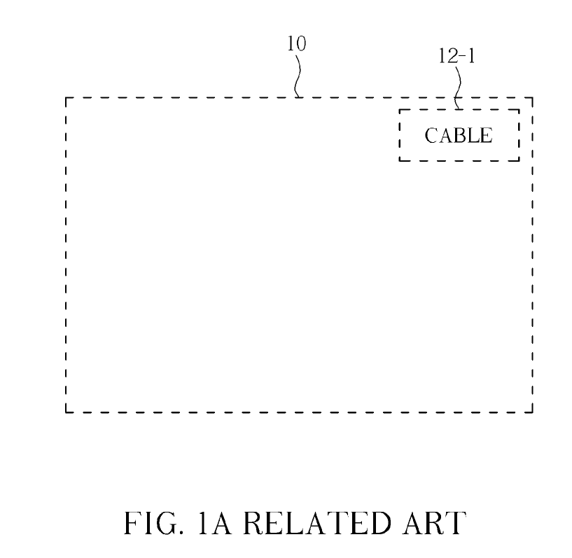

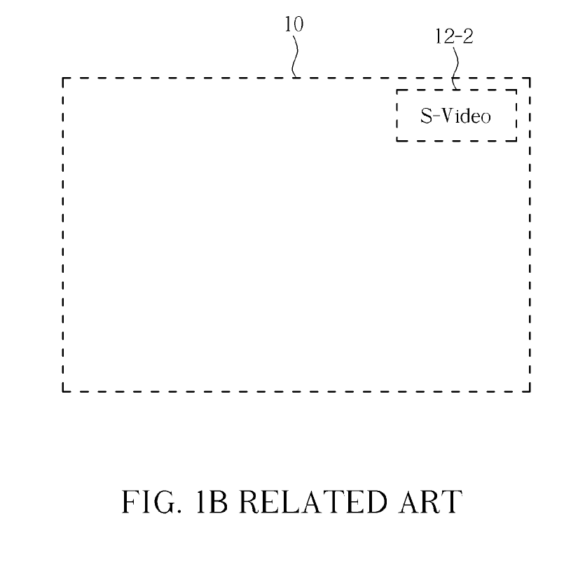

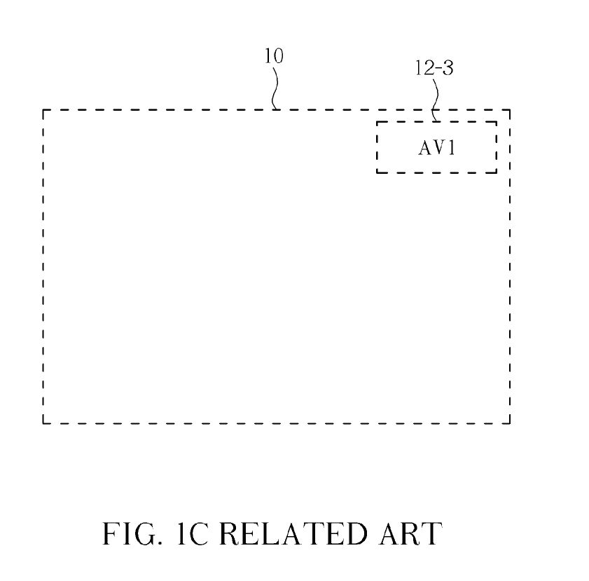

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

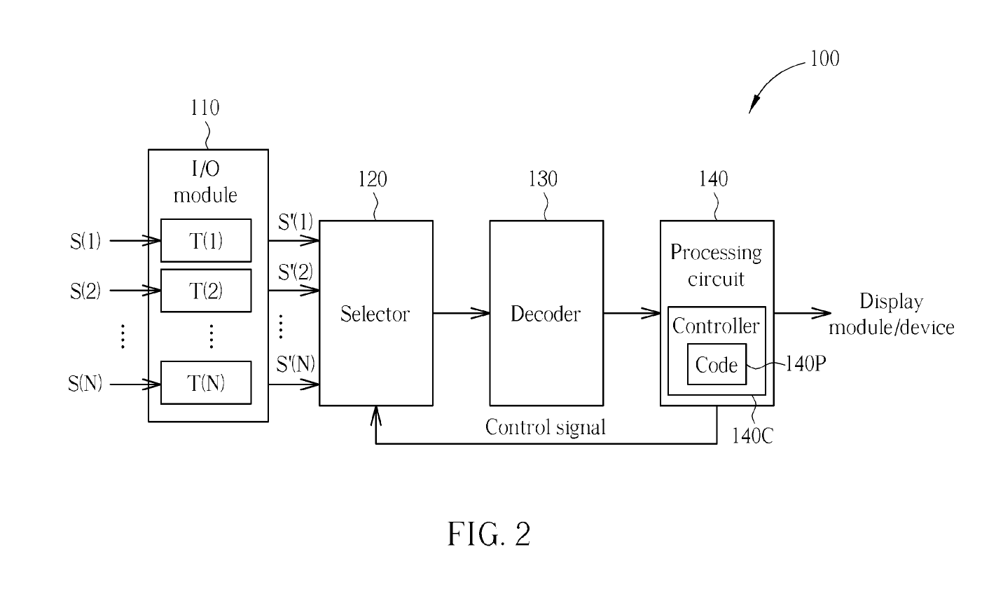

Please refer to FIG. 2, which illustrates a diagram of a video playback device 100 provided with a source selection function according to a first embodiment of the present invention. The video playback device 100 comprises an input/output (I/O) module 110, a selector 120, a decoder 130, and a processing circuit 140, where the I/O module 110 comprises two or more input terminals such as input terminals T(1), T(2), . . . , and T(N), and the processing circuit 140 comprises a controller 140C executing program code 140P (labeled “Code” in FIG. 2). For example, the video playback device 100 may represent a multi-channel broadcasting program receiver such as a television (TV) receiver, and the processing circuit 140 may output processing results to a display device such as a monitor. In another example, the video playback device 100 may represent a TV such as a liquid crystal display (LCD) TV, and the processing circuit 140 may output processing results to a display module of the LCD TV, such as an LCD panel.

In this embodiment, the controller 140C can be a hardware controller with the program code 140P embedded therein. This is for illustrative purposes only, and is not meant to be a limitation of the present invention. According to some variations of this embodiment, the controller 140C can be a micro control unit (MCU) or a micro processing unit (MPU), and the program code 140P may represent a program code received from outside the controller 140C. For example, the program code 140P can be firmware code stored in a memory (not shown) within the processing circuit 140 or the video playback device 100. In another example, the program code 140P can be software code stored in a memory/storage module (not shown) within the processing circuit 140 or the video playback device 100. That is, whether a program code such as the program code 140P is stored in a memory/storage module such as any of those mentioned above depends on different variations of this embodiment.

According to this embodiment, the processing circuit 140 is arranged to provide the video playback device 100 with a user interface of the source selection function for displaying image representatives of a plurality of input terminals of the video playback device 100 (e.g. a portion or all of the input terminals T(1), T(2), . . . , and T(N) shown in FIG. 2) at the same time. In addition, the selector 120 is arranged to select a signal corresponding to a specific input terminal of the input terminals (e.g. a signal S′(n) corresponding to an input terminal T(n) that is utilized for receiving the input signal S(n), with n varying within at least a portion of the interval [1, N]) in response to user selection, in order to make images carried by the selected signal be displayed.

More specifically, the processing circuit 140 is utilized for controlling the video playback device 100 and providing the video playback device 100 with the source selection function. In practice, the controller 140C therein is arranged to control operations of the video playback device 100. The controller 140C executing the program code 140P is arranged to provide the user interface of the source selection function for displaying the image representatives mentioned above at the same time. Under control of the processing circuit 140, the selector 120 is arranged to select the signal S′(n) corresponding to the specific input terminal T(n) in response to user selection, in order to make images carried by the selected signal S′(n) be displayed.

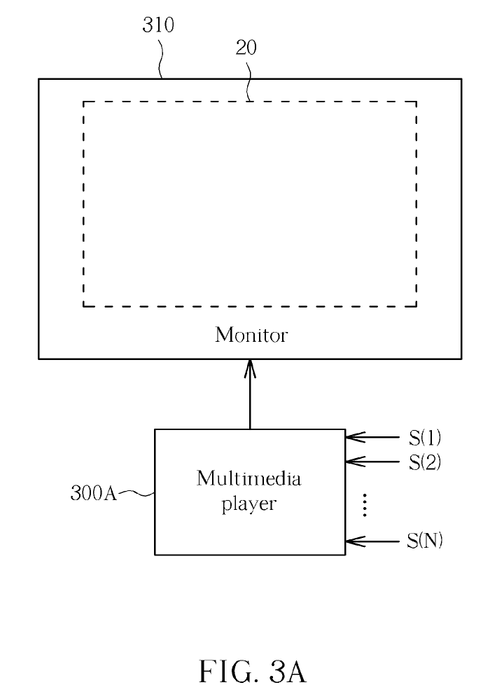

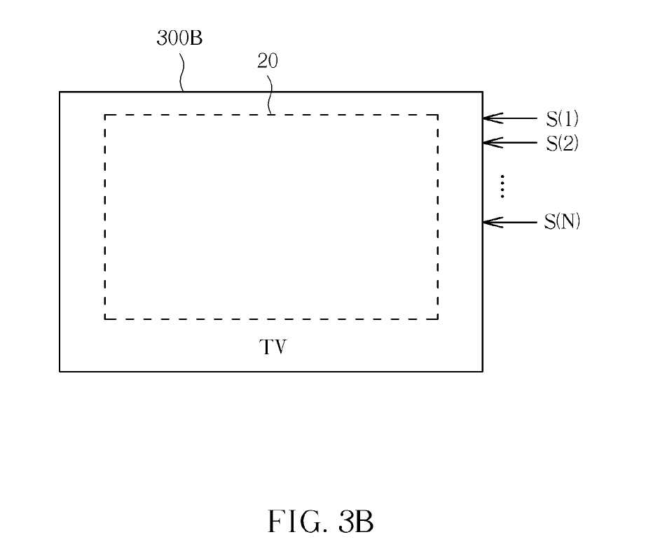

FIGS. 3A-3B illustrate some examples of the video playback device 100 shown in FIG. 2 according to different embodiments of the present invention. Referring to FIG. 3A, the video playback device 100 may represent a multimedia player 300A such as a digital versatile disc (DVD) player or a Blu-ray Disc (BD) player, and the processing circuit 140 may output processing results to a display device such as the monitor 310 having a screen 20. Thus, the video playback device 100 (e.g. the multimedia player 300A) is a video source of the display device (e.g. the monitor 310). In another example, the video playback device 100 may represent a TV 300B such as an LCD TV, and the processing circuit 140 may output processing results to a display module of the LCD TV, such as an LCD panel. Thus, the video playback device 100 (e.g. the TV 300B) comprises the display module for displaying the image representatives, where the video playback device 100 is substantially a TV provided with the source selection function mentioned above.

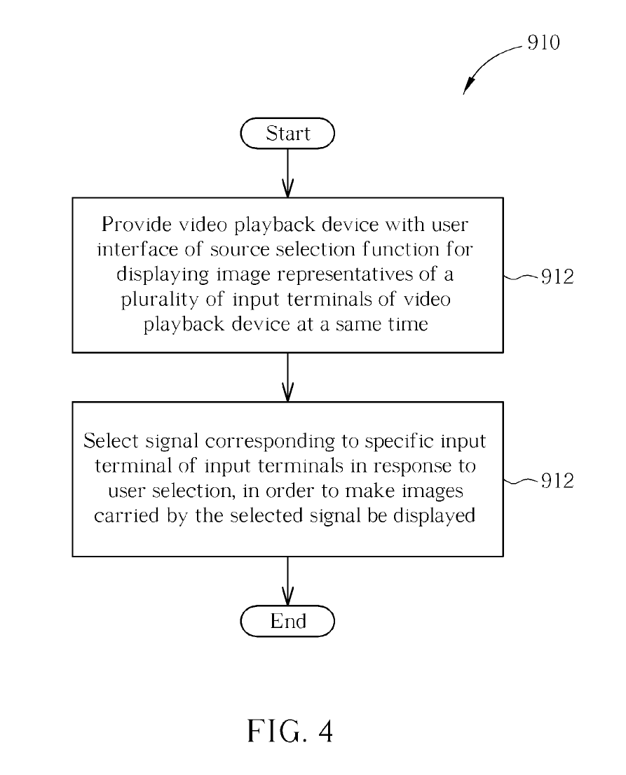

FIG. 4 is a flowchart of a method 910 for providing a video playback device with a source selection function according to an embodiment of the present invention. The method 910 can be applied to the video playback device 100 shown in FIG. 2, and more particularly, the processing circuit 140 therein. In addition, the method 910 can be implemented by utilizing the video playback device 100 shown in FIG. 2, and more particularly, the processing circuit 140 therein. The method 910 is described as follows.

In Step 912, the processing circuit 140 (and more particularly, the controller 140C executing the program code 140P) provides the video playback device 100 with the user interface of the source selection function for displaying image representatives of a plurality of input terminals of the video playback device 100 (e.g. a portion or all of the input terminals T(1), T(2), . . . , and T(N)) at the same time. For example, the plurality of input terminals represents all of the input terminals T(1), T(2), . . . , and T(N), and the user interface provides each of the input terminals T(1), T(2), . . . , and T(N) with an associated image representative. In another example, the plurality of input terminals represents a portion of the input terminals T(1), T(2), . . . , and T(N), and the user interface provides each of the portion of the input terminals T(1), T(2), . . . , and T(N) with an associated image representative.

In Step 914, under control of the processing circuit 140, and more particularly, under control of a control signal sent from the processing circuit 140, the selector 120 selects the signal S′(n) corresponding to the specific input terminal T(n) in response to user selection, in order to make images carried by the selected signal S′(n) be displayed, where n varies within at least a portion of the interval [1, N]. Here, the signal S′(n) corresponds to the input signal S(n), where the I/O module 110 may output the input signal S(n) as the signal S′(n), or utilize an interfacing circuit (not shown) of the I/O module 110 to convert the input signal S(n) into a converted version thereof as the signal S′(n) when needed. In a situation where the plurality of input terminals represents all of the input terminals T(1), T(2), . . . , and T(N), n varies within the whole interval [1, N]. In a situation where the plurality of input terminals represents the portion of the input terminals T(1), T(2), . . . , and T(N), n varies within the portion of the interval [1, N].

According to this embodiment, when it is detected that at least one predetermined key of a remote controller of the video playback device 100 is pressed, the processing circuit 140 may activate the source selection function. In addition, when it is detected that there is no user activity for a predetermined time period (e.g. a few or several seconds, or ten or more seconds) after the source selection function is activated, the processing circuit 140 may inactivate the source selection function. In particular, according to a special case of this embodiment, the processing circuit 140 may prevent an image representative of any input terminal that receives no signal from being displayed when the source selection function is activated. Here, an input terminal T(n₁) that receives an input signal S(n₁) can be referred to as an active input terminal. In addition, an input terminal T(n₀) that receives no signal can be referred to as an inactive input terminal, and in this situation, the notation S(n₀) can be regarded as an input signal at a zero level. As a result of preventing an image representative of any inactive input terminal from being displayed, the user may quickly determine an input terminal to be selected among the active input terminals.

In practice, the image representatives can be implemented according to different strategies. For example, the image representatives may comprise at least one still image (e.g. one or more still images). In another example, the image representatives may comprise at least one video clip (e.g. one or more video clips). In another example, the image representatives may comprise at least one icon (e.g. one or more icons). This is for illustrative purposes only, and is not meant to be a limitation of the present invention. According to some of the strategies, the image representatives can be of the same type. For example, each of the image representatives can be a still image. In another example, each of the image representatives can be a video clip. In another example, each of the image representatives can be an icon.

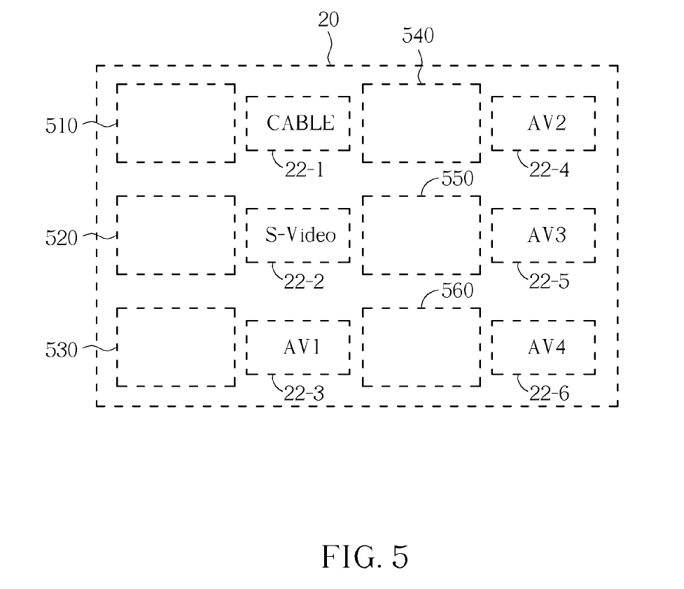

FIG. 5 illustrates an exemplary user interface arrangement according to a special case of the embodiment shown in FIG. 4. The input terminals T(1), T(2), . . . , and T(N) comprise input terminals named “CABLE”, “S-Video”, “AV1”, “AV2”, “AV3”, and “AV4”, respectively. In a situation where N=6 and the plurality of input terminals represents all of the input terminals T(1), T(2), . . . , and T(N), such as T(1), T(2), . . . , and T(6) in this special case, the user interface respectively provides the image representatives 510, 520, 530, 540, 550, and 560 of the input terminals T(1), T(2), . . . , and T(6), and further provides the respective input terminal names 22-1, 22-2, 22-3, 22-4, 22-5, and 22-6 of the input terminals T(1), T(2), . . . , and T(6).

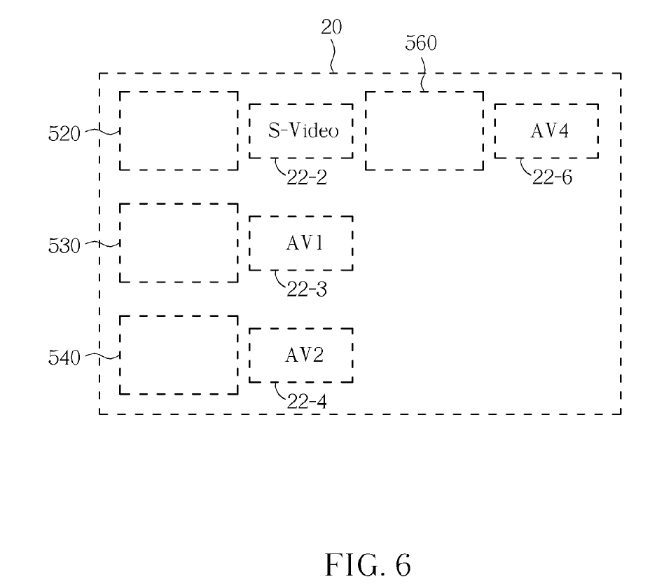

FIG. 6 illustrates an exemplary user interface arrangement according to another special case of the embodiment shown in FIG. 4. The input terminals T(1), T(2), . . . , and T(N) still comprise the input terminals named “CABLE”, “S-Video”, “AV1”, “AV2”, “AV3”, and “AV4”, respectively. In a situation where N=6 and the plurality of input terminals represents at least a portion of the input terminals T(1), T(2), . . . , and T(N), such as active input terminals T(2), T(3), T(4), and T(6) in this special case, the user interface respectively provides the image representatives 520, 530, 540, and 560 of the input terminals T(2), T(3), T(4), and T(6), and further provides the respective input terminal names 22-2, 22-3, 22-4, and 22-6 of the input terminals T(2), T(3), T(4), and T(6).

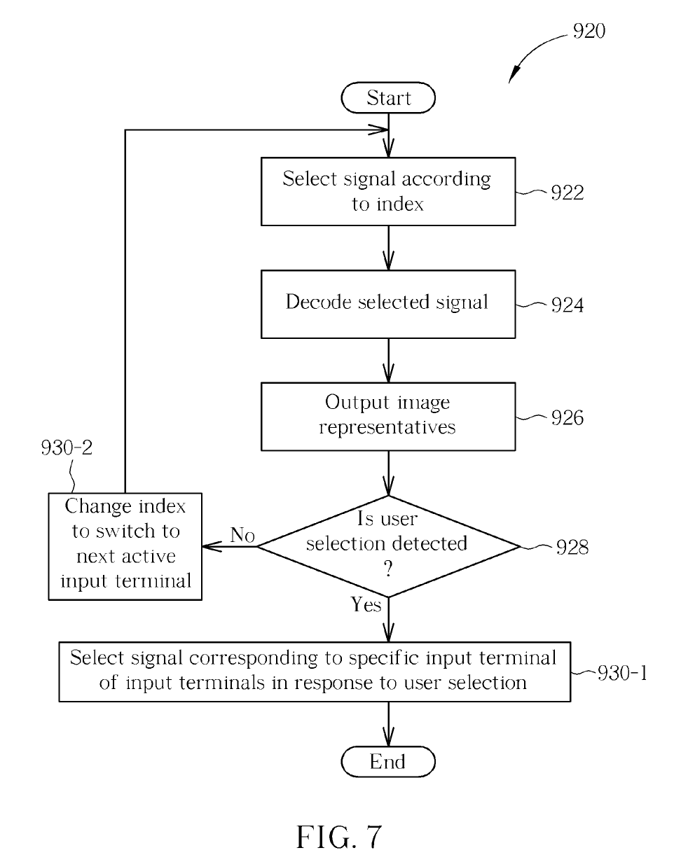

FIG. 7 illustrates implementation details of the method 910 shown in FIG. 4 according to an embodiment of the present invention, where this embodiment is a variation of the embodiment shown in FIG. 6. The working flow 920 is described as follows.

In Step 922, the selector 120 selects a signal according to an index. More particularly, the selector 120 selects the signal S′(n) according to the index n. In this embodiment, n varies within at least a portion of the interval [1, N], and more particularly, the portion corresponding to the active input terminals, such as the input terminals T(2), T(3), T(4), and T(6) of the embodiment shown in FIG. 6.

In Step 924, the decoder 130 decodes the selected signal, such as the signal S′(n) mentioned in Step 922.

In Step 926, the processing circuit 140 (and more particularly, the controller 140C executing the program code 140P) outputs the image representatives, such as the latest versions of the image representatives of the active input terminals (e.g. the latest versions of the image representatives 520, 530, 540, and 560). In particular, the processing circuit 140 updates the image representative of the input terminal T(n). For example, the latest version of the image representative of the input terminal T(n) comprises the latest image(s) carried by the signal S′(n), such as the latest still image or the latest video clip decoded from the signal S′(n).

In Step 928, the processing circuit 140 (and more particularly, the controller 140C executing the program code 140P) checks whether user selection is detected. When user selection is detected, Step 930-1 is entered; otherwise, Step 930-2 is entered.

In Step 930-1, under control of the processing circuit 140 (and more particularly, the controller 140C executing the program code 140P), the selector 120 selects the signal corresponding to a specific input terminal of the input terminals T(1), T(2), . . . , and T(N) in response to user selection. In particular, the selector 120 selects the specific input terminal out of the active input terminals, such as the input terminals T(2), T(3), T(4), and T(6) of the embodiment shown in FIG. 6, in response to user selection.

In Step 930-2, the processing circuit 140 (and more particularly, the controller 140C executing the program code 140P) changes the index mentioned in Step 922, such as the index n, to switch to the next active input terminal.

Please note that the active/inactive states of the input terminals may vary as time goes by. According to this embodiment, the processing circuit 140 (and more particularly, the controller 140C executing the program code 140P) dynamically changes the user interface, so that the image representatives of the latest active input terminals can be displayed. In addition, the processing circuit 140 (and more particularly, the controller 140C executing the program code 140P) can prevent the image representatives of the latest inactive input terminals from being displayed. This is for illustrative purposes only, and is not meant to be a limitation of the present invention. According to a variation of this embodiment, the processing circuit 140 (and more particularly, the controller 140C executing the program code 140P) does not dynamically changes the user interface in response to the change of the active/inactive states of the input terminals.

It is an advantage of the present invention that the present invention method and the associated video playback device can provide the user interface of the source selection function for displaying the image representatives of a plurality of input terminals of the video playback device at the same time. As a result, the user can quickly determine an input terminal to be selected among the plurality of input terminals, and the related art problems such as those mentioned above will never occur.

It is another advantage of the present invention that, in a situation where the plurality of input terminals are active input terminals and the processing circuit 140 can prevent an image representative of any inactive input terminal from being displayed, the user may quickly determine an input terminal to be selected among the active input terminals. In addition, in a situation where a plurality of users may use the video playback device of the present invention in turns, when the video playback device is turned on and the screen displays nothing, the processing circuit may activate the source selection function automatically, or activate the source selection function in response to one or more user activities (e.g. the aforementioned at least one predetermined key of the remote controller of the video playback device 100 is pressed). Thus, those who are not familiar with the connection relationships between the input terminals and the source devices will never be forced to waste time on figuring out what to do next or blindly trying with some other input terminals. Therefore, the viewing experience of the users can be greatly enhanced.

Those skilled in the art will readily observe that numerous modifications and alterations of the device and method may be made while retaining the teachings of the invention.

1. A method for providing a video playback device with a source selection function, the method comprising:
providing the video playback device with a user interface of the source selection function for displaying image representatives of a plurality of input terminals of the video playback device at a same time; and
selecting a signal corresponding to a specific input terminal of the input terminals in response to user selection, in order to make images carried by the selected signal be displayed.

2. The method of claim 1, further comprising:
when it is detected that at least one predetermined key of a remote controller of the video playback device is pressed, activating the source selection function.

3. The method of claim 2, further comprising:
when it is detected that there is no user activity for a predetermined time period after the source selection function is activated, inactivating the source selection function.

4. The method of claim 1, further comprising:
preventing an image representative of any input terminal that receives no signal from being displayed when the source selection function is activated.

5. The method of claim 1, wherein the image representatives comprise at least one still image.

6. The method of claim 1, wherein the image representatives comprise at least one video clip.

7. The method of claim 1, wherein the image representatives comprise at least one icon.

8. The method of claim 1, wherein the video playback device comprises a display module for displaying the image representatives.

9. The method of claim 8, wherein the video playback device is a TV provided with the source selection function.

10. The method of claim 1, wherein the video playback device is a video source of a display device.

11. A video playback device provided with a source selection function, the video playback device comprising:
a processing circuit arranged to provide the video playback device with a user interface of the source selection function for displaying image representatives of a plurality of input terminals of the video playback device at a same time; and
a selector arranged to select a signal corresponding to a specific input terminal of the input terminals in response to user selection, in order to make images carried by the selected signal be displayed.

12. The video playback device of claim 11, wherein when it is detected that at least one predetermined key of a remote controller of the video playback device is pressed, the processing circuit activates the source selection function.

13. The video playback device of claim 12, wherein when it is detected that there is no user activity for a predetermined time period after the source selection function is activated, the processing circuit inactivates the source selection function.

14. The video playback device of claim 11, wherein the processing circuit prevents an image representative of any input terminal that receives no signal from being displayed when the source selection function is activated.

15. The video playback device of claim 11, wherein the image representatives comprise at least one still image.

16. The video playback device of claim 11, wherein the image representatives comprise at least one video clip.

17. The video playback device of claim 11, wherein the image representatives comprise at least one icon.

18. The video playback device of claim 11, wherein the video playback device comprises a display module for displaying the image representatives.

19. The video playback device of claim 18, wherein the video playback device is a TV provided with the source selection function.

20. The video playback device of claim 11, wherein the video playback device is a video source of a display device.

21. A processing circuit for controlling a video playback device and providing the video playback device with a source selection function, the processing circuit comprising:
a controller arranged to control operations of the video playback device; and
a program code embedded in the controller or received from outside the controller, wherein the controller executing the program code is arranged to provide a user interface of the source selection function for displaying image representatives of a plurality of input terminals of the video playback device at a same time;
wherein under control of the processing circuit, a selector of the video playback device is arranged to select a signal corresponding to a specific input terminal of the input terminals in response to user selection, in order to make images carried by the selected signal be displayed.

22. The processing circuit of claim 21, wherein when it is detected that at least one predetermined key of a remote controller of the video playback device is pressed, the processing circuit activates the source selection function.

23. The processing circuit of claim 22, wherein when it is detected that there is no user activity for a predetermined time period after the source selection function is activated, the processing circuit inactivates the source selection function.

24. The processing circuit of claim 21, wherein the processing circuit prevents an image representative of any input terminal that receives no signal from being displayed when the source selection function is activated.

25. The processing circuit of claim 21, wherein the image representatives comprise at least one still image.

26. The processing circuit of claim 21, wherein the image representatives comprise at least one video clip.

27. The processing circuit of claim 21, wherein the image representatives comprise at least one icon.
